(19) United States
(12) Patent Application Publication
(10) Pub. No.: US 2025/0103900 A1
(43) Pub. Date: Mar. 27, 2025

(54) FEDERATED LEARNING WITH FOUNDATION MODEL DISTILLATION

(71) Applicant: Robert Bosch GmbH, Stuttgart (DE)

(72) Inventors: Xidong WU, Pittsburgh, PA (US); Filipe J. CABRITA CONDESSA, Pittsburgh, PA (US); Wan-Yi LIN, Wexford, PA (US); Devin T. WILLMOTT, Pittsburgh, PA (US); Zhenzhen LI, Gibsonia, PA (US); Madan Ravi GANESH, Pittsburgh, PA (US)

(21) Appl. No.: 18/371,476

(22) Filed: Sep. 22, 2023

(51) Int. Cl. G06N 3/098; G06N 3/045

(52) U.S. Cl. CPC G06N 3/098; G06N 3/045

(57) ABSTRACT

Methods and systems of training neural networks with federated learning. Machine learning models are sent from a server to clients, yielding local machine learning models. At each client, the models are trained with locally-stored data, including determining a respective cross entropy loss for each of the plurality of local machine learning models. Weights for each local model are updated, and transferred to the server without transferring locally-stored data. The transferred weights are aggregated at the server to obtain an aggregated server-maintained machine learning model. At the server, a distillation loss based on a foundation model is generated. The aggregated server-maintained machine learning is updated to obtain aggregated respective weights, which are transferred to the clients for updating in the local models.

### TECHNICAL FIELD

The present disclosure relates to methods and systems of federated learning with foundation models in machine learning models.

### BACKGROUND

Federated learning (a type of collaborative learning) is a machine learning technique that trains a machine learning algorithm via multiple independent nodes, each using its own dataset. Federated learning aims at training a global machine learning algorithm, for instance deep neural networks, based on multiple local datasets contained in local nodes (also referred to as clients) without explicitly exchanging data samples. The learning task is solved by a federation of participating devices coordinated by a central server. Each participating device (client) has a local training dataset which is not uploaded to the server or shared with other clients. Instead, each client computes an update to the current global model maintained by the server. The clients communicate this update, but not the training dataset, to the server. The server aggregates the received update to update the global model. The resulting shared model can be trained by learning from the training of the clients, thus allowing users to reap the benefits of shared models trained from the data of the clients without having to transfer or centrally store the data from the clients. This has particular usefulness in situations where the exchange of sensitive or personal data is precluded (e.g., medical information, Internet of Things devices, personal devices such as smart phones).

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3A shows an example diagram or layout of a federated learning system, that includes a foundational model according to an embodiment;

FIG. 3B shows a flow chart of a first exemplary method of training neural networks via client-side federated learning according to a first embodiment.

FIG. 3C shows a flow chart of a second exemplary method of training neural networks via server-side federated learning according to a second embodiment.

FIG. 4 shows a schematic of a deep neural network with nodes in an input layer, multiple hidden layers, and an output layer, according to an embodiment.

FIG. 5 depicts a schematic diagram of an interaction between a computer-controlled machine and a control system, according to an embodiment.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to an embodiment.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver, that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

The present disclosure relates to federated learning. References herein to a “server” of the federated learning system refer to the centralized server(s) that communicate to the clients to exchange data therewith. For example, one or more servers in the cloud or remote from end users can constitute a server. References herein to a “client” of the federated learning system refer to local nodes or devices corresponding to a particular end user. For example, a smart phone, Internet of Things device, or the like would constitute a client. Each of the server and the client can utilize a respective computer system for machine learning training, such as those described herein.

Federated learning (also known as collaborative learning) is a machine learning technique that trains a machine learning algorithm via multiple independent sessions, each using its own dataset. Federated learning aims at training a global machine learning model (e.g., deep neural networks) based on multiple local datasets contained in local nodes (also referred to as clients) without explicitly exchanging data samples. The learning task is solved by a federation of participating devices coordinated by a central server. Each participating device (client) has a local training dataset which is not uploaded to the server. Instead, each client computes an update to the current global model maintained by the server. The clients communicate this update, but not the training dataset, to the server. The server aggregates the received update to update the global model. The resulting shared model can be trained by learning from the training of the clients, thus allowing users to reap the benefits of shared models trained from the data of the clients without having to transfer or centrally store the data from the clients.

Federated learning has particular usefulness in situations where the exchange of sensitive or personal data is precluded (e.g., medical information, Internet of Things devices, personal devices such as smart phones). Take smart phones as a simple, everyday example. When people type an email or text message, they might have an auto-correct or auto-fill feature that will automatically correct a person's spelling mistake or suggest corrections or additions to the text. This sort of system typically relies upon a machine learning model that is trained based on previous word usage of the user, and might differ from user to user. Because of the sensitive nature of the information used, the raw data of the words types by the user is not sent to a central server to train the model. Rather, the user's smart phone can receive a base model from the server, and can train that model locally to perform auto-correct in a manner that is tailored to that particular user's history of word usage. Information about how the model was trained locally can be sent to the server without requiring the raw data (e.g. the user's words and/or the corrections) to be sent to the server.

Federated learning is a technique that enables data to remain locally stored on clients' devices while the server functions as orchestrator for the learning process, aggregate learned information and synchronize with clients (e.g. users, AI tasks, . . . ). However, the system can experience reduced efficiency and robustness due to issues like data heterogeneity, distribution shifts, and communication can be unreliable and even in cases with hardware failures. Additionally, various federated learning architectures have been proposed, such as single global models and peer-to-peer with individual models, some of which include personalized versions.

FedAvg is a type of federated learning technique in which a distributed machine learning algorithm allows clients to collaboratively train a global server model while keeping their data locally stored and private. It works by sending the initial model from the server to clients, aggregating the clients' updates into a global model by averaging the clients' updates, and repeating this process until convergence is achieved. FedAvg enables updating the global model by aggregating the knowledge and insights of multiple clients. A typical federated learning system suffers from issues like reduced performance and robustness, especially when confronted with issues like data heterogeneity and distributions shifts. Recently, foundation models that are pretrained on a vast amount of data have been widely adapted as an initialization for model parameters. In the scenario where clients have access to their own foundation models but have strong privacy concerns their maximum achievable performance would be restricted.

Given the aforementioned challenges and the variety of federated learning architectures and frameworks, the present disclosure aims to address these issues by proposing a novel federated learning framework utilizing foundation models locally within clients to improve their performance while using a smaller proxy model to coordinate and synchronize information across various clients. Although others suggest the use of foundation models within clients to improve their personalization capabilities, they suggest directly customizing the foundation model directly, by adding adaptation layers or prompts. They do not use distilled knowledge from foundation models to guide the smaller-sized proxy model's training.

To address the problems of representation insufficiency as well as computational efficiency, this disclosure proposes embodiments including the following method. Clients have the freedom choose their own foundation models instead of using the same foundation model used in the literature. By consistently distilling the performance from foundation models to a smaller student model in the clients end and updating the student model with aggregated weights from the server, our framework leverages the prior knowledge from pre-trained foundation models while retaining information presented by the client population. The clients distill knowledge from their own choices of pre-trained foundation models, fine-tuned on local data and have access to aggregated knowledge under the federated learning setting. Thus, our framework balances an efficient communication setup, across the server and clients, with privacy gained from not directly exposing the foundation model and a high level of performance and robustness achievable using foundation models.

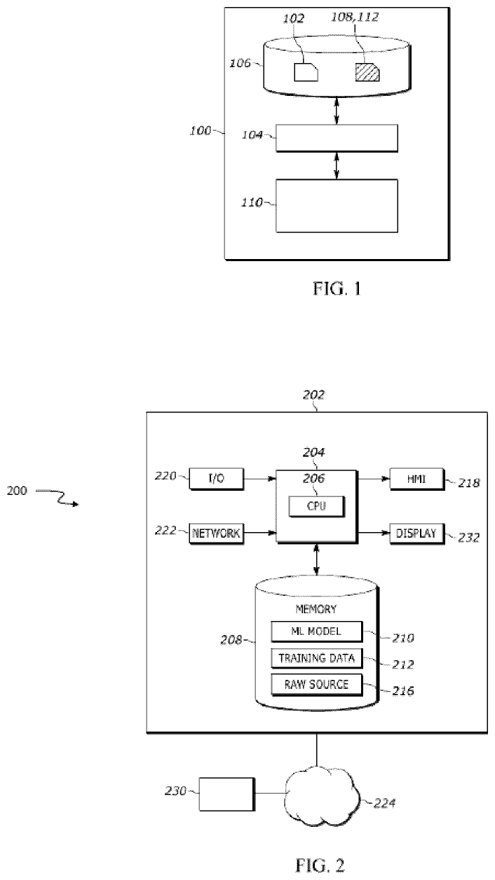

The federated learning system can utilize machine learning training and processes shown in FIGS. 1-2. FIG. 1 shows a system 100 for training a neural network, e.g. a deep neural network. The neural network being trained may reside on the server or the client. In other words, both the server and the client may utilize the teachings of FIG. 1. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network; this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

The structure of the system 100 is one example of a system that may be utilized to train the models utilized by the federated learning system described herein. Additional structure for operating and training these machine-learning models is shown in FIG. 2.

FIG. 2 depicts a federated learning system 200 configured to execute and train the machine-learning models described herein, for example the neural networks or deep neural networks. The system 200 can be implemented to perform the federated learning processes described herein. The system 200 may include at least one computing system 202. The computing system 202 may be part of or executed by a client device, such as a smart phone, Internet of Things device, medical device, or other device such as those described herein with reference to FIGS. 6-11 described below. By way of example and not by way of limitation, computing system 202 may be an embedded computer system, a system-on-chip (SoC), a single-board computer system (SBC) (such as, for example, a computer-on-module (COM) or system-on-module (SOM)), a laptop computer, a personal device such as a smart phone or tablet, a mesh of personal devices, or a combination of these. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system-on-chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud, enabling the device executing the computing system 202 (e.g., client device) to communicate with the server 230.

The external network 224 may be referred to as the world-wide web or the Internet. The external network 224 may establish a standard communication protocol between computing devices. The external network 224 may allow information and data to be easily exchanged between computing devices and networks.

One or more servers 230 may be in communication with the external network 224. Each server may include a computing system, such as computing system 202, so that the server 230 is configured to perform machine learning and train neural networks. Of course, in keeping with the spirit of this disclosure, certain personal or sensitive raw source data 216 that originate from a particular client device may not transfer to the server 230, and thus the raw source data at the server may be non-existent or may be completely independent of the raw source data on a computing system 202 of a client device. During operation of the federated learning system, as will be described below, the computing system 202 associated with a client device may exchange parts of the training data 212 but not the raw source data 216 or any personal data so as to preserve privacy for any sensitive personal data residing on the client device. The server 230 can then access this information via connection to the network 224, and update its stored models on the server-side.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuity or BUS networks to transfer information to or between the processor(s) and storage. For example, the I/O interface 220 can include digital I/O logic lines which can be read or set by the processor(s), handshake lines to supervise data transfer via the I/O lines, timing and counting facilities, and other structure known to provide such functions. Examples of input devices include a keyboard, mouse, camera, sensors, etc. Examples of output devices include monitors, screens, printers, speakers, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), or an output interface (in that it transfers data to an external output, such as a display).

The computing system 202 may include a human-machine interface (HMI) device 218 that may include any device that enables the system 200 to receive control input. Examples of input devices may include human interface inputs such as a keyboard, mouse, touchscreen, voice input devices (e.g., microphone), and other similar devices. The computing system 202 may include a display device 232. The computing system 202 may include hardware and software for outputting graphics and text information to the display device 232. The display device 232 may include an electronic display screen, projector, printer, speaker, or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. In particular, a client device may implement the computing system 202, and the server 230 may also include its own computing system 202. The particular system architecture selected may depend on a variety of factors.

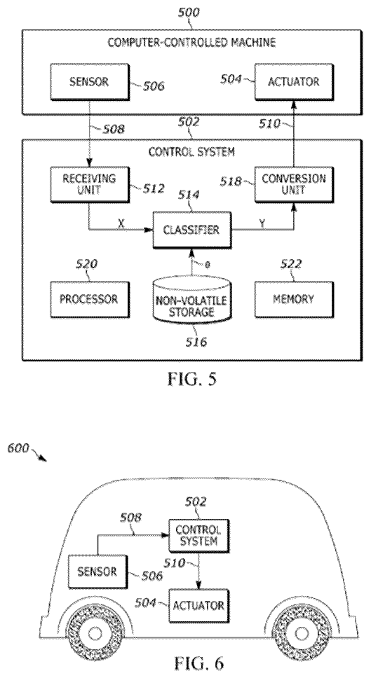

The federated learning system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). The raw source dataset 216 may include sensitive or personal data with heightened security necessities, and therefore the raw source dataset 216 may not transfer from the client device to the server 230. Several different examples of inputs are shown and described with reference to FIGS. 5-11. In some examples, the machine-learning algorithm 210 may be a neural network algorithm (e.g., deep neural network) that is designed to perform a predetermined function. For example, the neural network algorithm may be configured in automotive applications to identify street signs or pedestrians in images. The neural network algorithm may be configured to auto-correct text or speech based on the context of the words from the individual.

The computing system 202 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of a person in video images and annotate the occurrences. The machine-learning algorithm 210 may be programmed to process the raw source data 216 to identify the presence of the particular features. The machine-learning algorithm 210 may be configured to identify a feature in the raw source data 216 as a predetermined feature (e.g., a particular word, in the case where text or spoken words is the input). The raw source data 216 may be derived from a variety of sources. For example, the raw source data 216 may be actual input data collected by a machine-learning system. The raw source data 216 may be machine generated for testing the system. As an example, the raw source data 216 may include raw images or video from a camera, spoken words from a microphone, or typed or written words from a keyboard or touch screen, or the like.

Federated Learning (FL) is a distributed training paradigm that enables clients scattered across the real-world to cooperatively learn a global model while protecting data privacy. These clients typically have stringent restrictions on their communication bandwidth and inference speeds. However, heterogeneous data distributions across clients and the increased computational cost to maintain high performance under such settings without increasing the risk of data privacy exposure are critical bottlenecks that hinder the application of FL in practice. Typically, heterogeneous data distributions across clients lead to client drift, where the global model fails to reach its optimal point due to the diverging behavior between local models. When coupled with small-scale models to match inference speed and communication bandwidth constraints, there is an overall reduction in performance and robustness achievable in both global and local models. These issues are further compounded by data privacy concerns when information about local data may be re-engineered from standard model updates. To address these issues, a framework is presented here that leverages the performance of foundation models to help small-scale proxy models correct their local biases and improve the overall performance of the global model under non-IID (Independent and Identically Distributed) settings while maintaining differential privacy guarantees and fixed communication and inference budgets. A thorough evaluation of this framework under multiple settings is presented which highlights its effectiveness in improving the performance of smallscale models under strong non-IID conditions. In addition, the impact of fine-tuning foundation models on local data and how it detracts from obtaining a more optimal global model under strongly heterogeneous data distributions is presented.

Federated learning (FL) is a popular training paradigm in large-scale machine learning that can addresses cooperative learning across distributed clients, akin to real-world settings, while preserving the privacy of data stored within them. A typical FL framework may include of a central server that coordinates the training of a shared model by periodically averaging the local models from multiple clients, each of which are may only be trained using the data stored locally on the client. In practice, clients impose strict limitations on inference speeds and communications bandwidth, due to their deployment in real-world contexts, which in turn restricts them to using small-scale models. When coupled with heterogeneous data distributions and restrictions on data confidentiality these issues present significant challenges to the overall achievable performance and robustness.

Foundation models present a potential solution to addressing poor performance under heterogeneous data distributions, with known benefits of transferable representations across a broad range of downstream tasks and strong robustness to distribution shifts multiple recent methods explore fine-tuning transformer-based architectures and foundation models under federated settings. However, in some instances under extreme non-IID conditions, federated training of foundation models results in a performance worse than purely local training. In addition, existing methods do not discuss the relatively large increase in inference time when switching to foundation models instead of small-scale alternatives like EfficientNet, MobileNet, etc. Further, most federated training algorithms assume the exchange of a complete set or partial subset of weights with the server, which does not comply with the privacy constraint since it has been previously shown that by capturing gradient updates or weights, a malicious user can infer multiple properties of the original data distribution; and in turn use this information in an adversarial manner.

Keeping the considerations of heterogeneous data distributions, inference speed and privacy in mind, a novel federated training framework is presented that improves the overall performance of a smallscale model by distilling information from locally stored foundation models in clients. This framework allows clients the flexibility in the number and type of foundation models stored within each client which allows the small-scale model to reap the benefits of improved performance and robustness to non-IID distributions and privacy-based optimization schemes, both of which are known to decrease overall performance. In addition, this framework removes the computational burden of running a large foundation model during inference time by relying on the small-scale model to measure the overall performance of the client. By treating the foundation model as a local model, the smallscale model as a proxy that can be shared, and training them with privacy guaranteed optimization techniques can ensure that data privacy is maintained.

### Unique Aspects of This Framework Include

First, this framework is the first to leverage foundation models in federated learning settings under a restricted computational budget. The federated training framework increases the upper limit in performance and robustness achievable in small-scale client models under strict non-IID data settings.

Then by distilling knowledge from foundation models this framework can overcome the drop in overall performance observed when using optimization schemes with privacy guarantees.

Finally, this framework allows for the flexibility in the choice of locally stored foundation models, which allows clients to benefit from their choice of foundation models and scale of computation resources, without sacrificing the privacy of their models or inference speeds.

### Federated Learning

Federated learning is a distributed machine learning approach that enables multiple clients to collaboratively train a shared model while keeping their data local, thereby preserving data privacy. Consider using FedAvg to provide an effective solution to collaboratively training a global model using periodic model averaging. Then, adopting federated learning across a range of application domains including computer vision, natural language processing, speech recognition, health care, Internet of Things, and many others. More recently, there has been a concerted effort in tackling certain key aspects of federated learning such as, performance under heterogeneous data settings, reduced communication efficiency, improved privacy.

### Heterogenous Data Distributions

Typically, client data can naturally have non identical distributions which cause large drops in accuracy during federated training, such that naive aggregation such as FedAvg cannot guarantee model convergence to local minimum. One way to tackle such challenges includes personalized FL which adds a proximal term to local training objectives to allow variants in client model without over-fitting. Other ways to resolve this include regularization, model mixture, and clustered clients that may be used to stabilize FL with personal models. Also, the use of multi-task learning which perform different tasks simultaneously, and meta-learning that has rapid adaptation of a global model to each client's local data distribution may be used to alleviate the problem. In this work, the issue of heterogeneous data distributions through the use of foundation models is addressed since these may provide a more general solution while maintaining the same amount of data as conventional FL methods.

### Foundation Models

Foundation models may have benefits in specific areas such as the integration of language, vision, and multi-modal pre-training approaches. Leveraging the power of pre-training on large-scale datasets can seamlessly apply these models to a wide range of tasks. This framework can apply foundation models in FL to improve the robustness of clients to distribution shifts and heterogeneous data distributions, or improving the overall performance of the system. Although foundation models strongly benefit performance under heterogeneous data settings, directly training and evaluating on foundation models increases the computational burden on the client and increases the latency during inference. This hinders their deployment under real-world settings. Instead, this framework leverages the benefits of foundation models, stored locally, to help improve the performance and robustness of small-scale models while maintaining low communication and inference overheads.

### Inference Efficiency

Turning to FL strategies that tackle the problem of inference efficiency. For example, consider employing dropout to ensure inference remains efficient, or a method to adaptively prune parameters during federated training, or providing theoretical analysis for the design strategy involved in a local models' pruning mask. Consider federated learning with personalized and structured sparse masks or creating diverse local models as subnets of the global network by selecting key continuous parameters layer by layer through structured pruning along with the aid of static batch normalization. An important distinction between existing works that address inference efficiency and the approach presented here is their use of pruning as a platform to personalize and improve the communication and inference times per client. Instead, this disclosure fixes the available budget and proceeds to improve the upper limit on performance of the smaller models. These two approaches are complementary and can be combined to further magnify their impact.

### Privacy

To mitigate data privacy concerns in FL, consider an FL framework which allows clients to train a meme/proxy model and a private model using mutual learning. The meme/proxy model may be only shared with server, thus reducing the risk of data exposure. However, there may be vulnerabilities associated with the capture of model weights/updates during the exchange of information between clients and the server. To provide a stronger privacy protection, one can use methods like differential privacy, secure multiparty computation, secret sharing, homomorphic encryption and hybrid methods. To address the privacy concern in FL, ProxyFL may use a formulation in which clients maintain a private and a proxy model that are trained using mutual learning. The client exclusively communicates with others through the exchange of their proxy model, ensuring both data and model privacy. However, in ProxyFL each client may use DP-SGD during training, which provides measurable guarantees for differential privacy. In a similar fashion, consider an FL framework based on differential privacy (DP) by adding artificial noise to parameters during local training in the clients to obfuscate and protect information about client data distributions. Inspired by methods proposed to actively tackle privacy concerns, this framework may adopt the method proposed in ProxyFL and utilize the impact of distillation from foundation models on the performance of DP based optimizers.

### Distillation

Knowledge distillation is a teaching technique that can transfer valuable insights and generalization capabilities of a teacher model to a student model. Within the domain of FL, this framework explores adaptable aggregation methods with ensemble distillation to fuse model on the server and then considers an auxiliary dataset to weight and ensemble local models from each client. Consider FedDistill, a method that extracts statistics related to the logit-vector from client models which are then shared with other clients to facilitate knowledge distillation. Further, consider a data-free knowledge distillation approach (FEDGEN) to address data heterogeneity in FL, where at the server they train a generative model by combining client information and use the data from the generator to help improve the performance of client models. Or, a co-distillation based personalized federated learning method to allow cross-architecture training. In this framework, the impact of the base formulation of knowledge distillation on the performance of the small-scale model while avoiding the use of excess data, augmentations, or model sharing is considered so as to provide guidance with respect to how can foundation models be effectively used in federated learning.

### Leveraging Foundation Models in Federated Learning

Consider the conventional FL framework FedAvg shown below and then augmented by this disclosure's framework's key components.

### Standard FL Framework

FedAvg can be succinctly described by the following equation,

$$\text{?} f ( θ ) := \frac{1}{N} \text{?} f ( {θ}^{i} ) \qquad ( 1 )$$

$$\text{?} \text{indicates text missing or illegible when filed}$$

where θ∈R^{d} denotes the global model's parameters and N indicates the number of clients. f(θⁱ) is the loss function of the i^{th} client, where each client contains it's local data distribution denoted by Dⁱ.

### Approach

This disclosure presents a new framework in which each of the N clients contains two different kinds of local models: (a) pre-trained foundation models (private) θ_{FM}_{ⁱ}₁, θ_{FM}_{ⁱ}₂, . . . , θ_{FM}_{ⁱ}_{Mi}, and (b) small-scale model (proxy) denoted by θ_{S}ⁱ. In this framework, the objective of FL remains the same as Eq. 1, where the models being optimized are the small-scale proxy models.

### Framework Core

A summary of the core of the framework in illustrated in Algorithm 1. During training, the server obtains the locally updated small-scale models from each client. These models are aggregated using formulations similar to Eq. 1 or more complex weighting schemes such as

$$\text{?} θ := \frac{\text{?}}{\vert \text{?} \vert} \text{?} , \qquad ( 2 )$$

$$\text{?} \text{indicates text missing or illegible when filed}$$

that accounts for the distribution of data across clients.

After model aggregation is complete, the server broadcasts the aggregated model to each client where they update their local small-scale model's weights using the aggregated model. Within each client, the small-scale model is trained on the local data distribution using the following loss,

$$ℒ ( {θ}_{S}^{i} ) = λ {ℒ}_{CE} ( {θ}_{S}^{i} ) + ( 1 - λ ) {ℒ}_{Distill} ( {θ}_{S}^{i} , \text{?} , … , \text{?} ) , \qquad ( 3 )$$

$${ℒ}_{CE} ( \text{?} ) = \text{?} ( h ( x ; \text{?} ) , y ) \qquad ( 4 )$$

$$\text{?} ( {θ}_{S}^{i} , \text{?} , … , \text{?} ) = \text{?} [ h ( x ; \text{?} ) \vert \vert \text{?} ( x ; \text{?} ) ] \qquad ( 5 )$$

$$\text{?} \text{indicates text missing or illegible when filed}$$

Algorithm 1 Framework

```
  1: Input: Dataset [symbol] , Frozen foundation models [symbol] , and student model h with parameters θᵢ;
  i = 1 . . . N.
  2: Sever executes:
  3: for each round t = 1, 2, . . . , T do
  4:  for each client i = 1, 2, . . . , N in parallel do
  5:  θₜⁱ ← LocalUpdate(θₜ)
  $6 : \text{?} = \frac{1}{N} {\sum }_{i ∈ N} \text{?}$
  7:  end for
  8: end for
  9: LocalUpdate(θₜ)
10: θ_{t,0}ⁱ = θₜ
11: for each epoch q = 1, 2, . . . , Q do
12:  for each each batch Bᵢ ~ [symbol]  do
13:  θ_{t,q}ⁱ = θ_{t,q-1}ⁱ − η∇ [symbol] (θ_{t,q-1}ⁱ)
14:  end for
15: end for
16: return: θ_{t,Q}ⁱ
$\text{?} \text{indicates text missing or illegible when filed}$
```

where L_{CE} is the cross-entropy loss, L_{Distill} is the Kullback Leibler (KL) Divergence loss used to distill knowledge from the foundation model to the small-scale proxy model. The parameter λ controls the proportion of knowledge distilled from foundation model in comparison to ground truth labels. Once the local training is complete, each client pushes their local small-scale model to the server, and the entire process of aggregation, broadcast and client update is repeated until convergence.

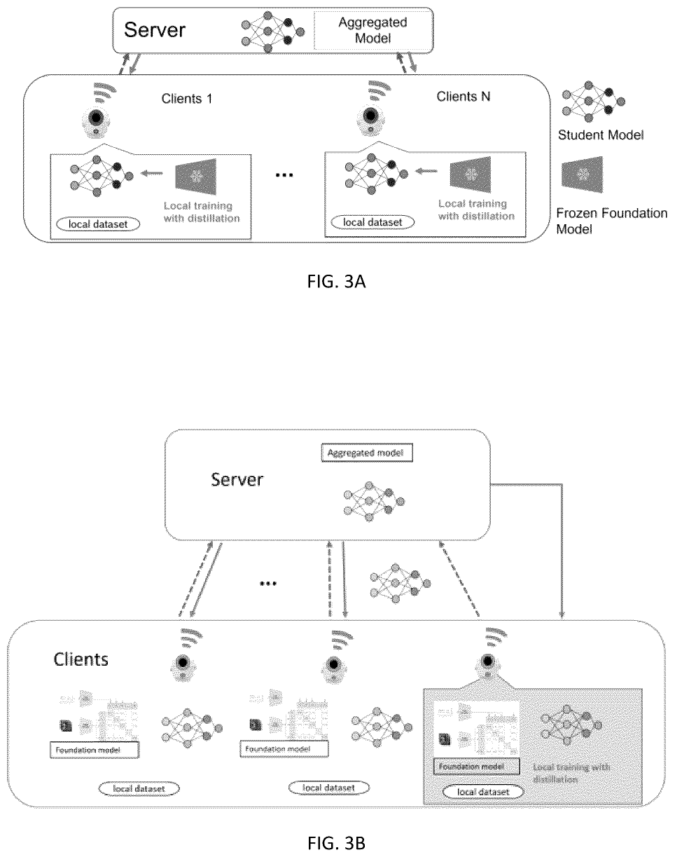

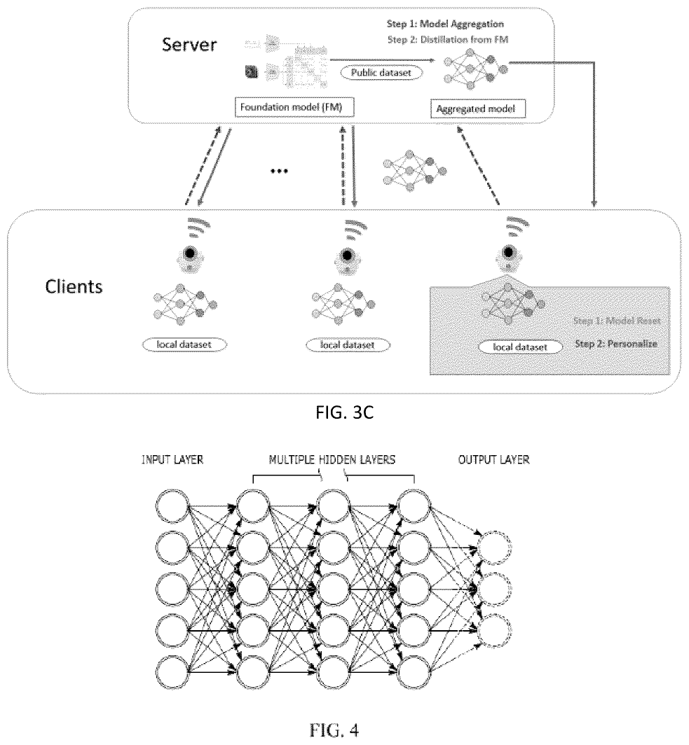

FIG. 3A: Overview of the proposed lightweight federated learning framework. For each client, there are two models, the student model and the frozen foundation model. The frozen foundation model generates the logit to guide the training of student models. Aggregated model by the server to aggregate information from different local models without observing their data. At the inference phase, the foundation model is discarded.

Consider a first exemplary embodiment, recalling that federated learning is the process of cooperatively learning across clients while preserving the privacy of the data stored within them. The server acts as the supervisor for the learning process, by receiving and aggregating information provided from each client before sharing the aggregated model across all clients. A typical federated learning system suffers from issues like reduced performance and robustness, especially when confronted with issues like data heterogeneity and distributions shifts. Foundation models that are pretrained on a vast amount of data can be widely adapted as an initialization for model parameters. In the scenario where clients have access to their own foundation models but have strong privacy concerns their maximum achievable performance would be restricted.

Given the aforementioned challenges, this embodiment of the framework aims to address these issues by proposing the use of foundation models locally within clients to improve their performance while using a smaller student (proxy) model to coordinate and synchronize information across various clients. Then use distilled knowledge from foundation models to guide the smaller-sized model's training. This embodiment presents a framework to leverage the benefits of diverse feature embeddings from foundation models and distill knowledge to improve the learning performance across a variety of clients. This allows clients to choose their own foundation models instead of using the same foundation model. By consistently distilling the performance from foundation models to a smaller student model in the clients end and updating the student model with aggregated weights from the server, this framework leverages the prior knowledge from pre-trained foundation models while retaining information presented by the client population. The clients distill knowledge from their own choices of pre-trained foundation models, fine-tuned on local data and have access to aggregated knowledge under the federated learning setting. Thus, this framework balances an efficient communication setup, across the server and clients, with privacy gained from not directly exposing the foundation model and a high level of performance and robustness achievable using foundation models.

Here a focus on distilling knowledge from foundation models and training a smaller model. The distilled smaller model is broadcast to the server and receives an updated aggregated global model from the server. Then combines prototypes generated from pre-trained models with a contrastive loss to update the representations learned within individual clients. This embodiment offers an alternative solution that approaches the performance of foundation models while training a small-sized model. By distilling knowledge from its own choice of pre-trained foundation models, in conjunction with updates from clients and adaptation on local client's data, this framework provides a high performing, stable and small-scale base for the client. Because the choices of foundation models are private to the client, this embodiment preserves more privacy for the client compared to the use of the same foundation model across clients.

This embodiment can be used by training models with many different sensor input systems using federated/decentralized/collaborative learning in industrial IoT, sensor networks, and automation for production scenarios.

FIG. 3B is a flowchart for privacy-enhanced federated learning with client-side foundation models distillation where the server sends model weights, acquired and aggregated across all clients, to each client. At each client, the smaller model is initialized using the weights sent from the server. Then the model is updated using two losses, one which distills information from the pre-trained foundation models stored within the client and the second is cross-entropy loss. Once the smaller client model is updated, its weights are communicated to the server and the entire process repeats.

Assume N clients, each stores Mᵢ (i∈[N]) pre-trained foundation models alongside a smaller student model, and a central server hosting a smaller model. The choice of foundation models can cover a broad spectrum of variations including but not limited to variations in architecture, loss function, pre-training dataset, etc. The server contains a smaller model (θ_{S}) which matches the backbone of the client's model and is used as the primary synchronization point for the clients. Overall, the server acts as an orchestrator for federated training, to send and receive information from the clients.

Within each client i, the parameters of each of the Mᵢ foundation models and the distilled smaller model are denoted by θ_{FM}_{₁}ⁱ, θ_{FM}_{₂}ⁱ, . . . , θ_{FM}_{_{Mi}}ⁱ and θ_{DS}ⁱ respectively. Here, each client-i has access to locally stored data denoted by (Dⁱ, yⁱ). In addition, within the context of federated training there are some key parameters like, number of epochs a client is trained in between each communication (to server) round, batch size, learning rate, optimizer type, and so on.

### Input

Central server (orchestrator) hosts a smaller student model that mirrors the clients' model.

N clients in the federated learning system, with its locally stored data (Dⁱ, yⁱ) and initialized local models θ_{DS}¹, θ_{DS}², . . . , θ_{DS}^{N}, and stores M number of pre-trained foundation models.

### Steps

At the beginning of every round (r) of federated training, the server receives model weights from each client in [N]. The model weights are aggregated and used to initialize θ^{DS} in the following manner,

$${θ}_{S}^{r} = {\sum }_{k = 1}^{N} \frac{1}{\vert {D}^{k} \vert} {θ}_{DS}^{k} \qquad ( 6 )$$

Here, we assume data is sampled uniformly across all clients thus allowing us to attach reweighted importance to each client model.

After model aggregation described in the previous step is complete, the student model is broadcasted to each client.

After each client receives the information from the server, they reset their model by accepting and reinitializing their weights using the aggregated model, and begin to train on their local data, (Dⁱ, yⁱ), using the loss dictated by combining the distilled knowledge from the foundation models and adaptation to its local data. For the part of distilling knowledge from the pre-trained foundation models θ_{FM}_{₁}ⁱ, θ_{FM}_{₂}ⁱ, . . . , θ_{FM}_{_{Mi}}ⁱ on the local dataset (Dⁱ, yⁱ), the corresponding loss item is given by,

$${L}_{distill} = \frac{1}{\vert {M}_{i} \vert} {\sum }_{m = 1}^{{M}_{i}} {\sum }_{i = 1}^{C} {q}_{{FM}_{m}}^{i} log ( \frac{{q}_{{FM}_{m}}^{i}}{{q}_{DS}^{i}} ) , \qquad ( 8 )$$

termed the KL-Divergence loss [5] where

$${q}^{i} = \frac{exp ( {z}_{i} / T )}{{\sum }_{j = 1}^{C} exp ( {z}_{j} / T )} , {z}_{i}$$

denotes the logits of the i^{th} class and T denotes the distillation temperature. Combining the adaptation to local data training, the loss function is as follows:

$${min}_{{θ}^{i}} \frac{1}{\vert {D}^{i} \vert} {\sum }_{d ∈ {D}^{i}} l ( {q}^{i} , {y}^{i} ) + {L}_{distill} , \qquad ( 9 )$$

where l( ) is the cross-entropy loss function.

These set of operations are then repeated until the stop criterion is achieved (e.g., total number of rounds, loss/performance tolerance, etc.).

Consider a second exemplary embodiment, recalling that Federated learning is the process of cooperatively learning across clients while preserving the privacy of the data stored within them. The server acts as the supervisor for the learning process, by receiving and aggregating information provided from each client before sharing the aggregated model across all clients. Often, clients are deployed to solve problems in real-world contexts which constrains their infrastructure to limited compute resources, run-time, memory, etc. With this in mind, clients may not be suited to store and run state-of-the-art models, which are often extremely large in size. Thus, clients may be restricted to using small-scale models which limits the maximum possible performance that can be achieved. With such accommodations, the overall system can experience reduced performance and robustness, especially when confronted with issues like data heterogeneity and distribution shifts that are common across federated learning.

Given the aforementioned challenges, this second embodiment aims to address these issues by proposing the use of foundation models within the server to coordinate and synchronize information across various clients. While the use of foundation models within clients to improve their personalization capabilities, restrictions in the compute resources of clients may not allow for the storage and execution of foundation models within all clients, regardless of whether all or a subset of contents from the foundation model are shared between the server and client. Consider combining the feature embeddings generated by pre-trained networks in a federated manner, while defaulting to the existence of pre-trained models within each client. This second embodiment presents a framework to leverage the benefits of diverse feature embeddings from foundation models placed within a central server to coordinate and improve the learning performance across a variety of clients without the additional overhead of sharing the foundation model directly. By consistently distilling the performance from frozen foundation models to a smaller student model in the server, which mirrors a model backbone that is more amenable to running on a client's device, in conjunction with updating the student model with aggregated weights from clients, our framework leverages the prior knowledge from pre-trained foundation models while retaining information presented by the clients. The clients in turn acquire a better initial model, the distilled student model in the server, and further fine-tune themselves on local data to improve their performance. Thus, this framework balances an efficient communication setup, across the server and clients, with the high level of performance and robustness achievable through the use of foundation models.

Along with the use of foundation models within individual clients of a federated system, this second embodiment focuses on adapting foundation models placed within a central server by distilling them into a smaller model. The distilled smaller foundation model simultaneously receives updates from all clients and then synchronously broadcasts an updated global model to each client. Combining prototypes generated from pre-trained models with a contrastive loss to update the representations learned within individual clients. And an alternative solution that approaches the performance foundation models while using a small-sized model that is more attuned to the available resources. By placing the foundation model on a central server and utilizing a distilled version of the model, in conjunction with updates from clients, the global distilled model provides a high performing, stable and small-scale base for the client, which can be further optimized using local data.

This embodiment can be used by training models with many different sensor input systems using federated/decentralized/collaborative learning in industrial IoT, sensor networks, and automation for production scenarios.

FIG. 3C is a flowchart for Federated learning with server-side foundation model distillation where the clients send locally adapted model weights to the server. At the server, all the clients' models are aggregated. Once aggregation is complete, the model is then updated by distilling from the foundation model using a public dataset after which the distilled model is broadcast to all the clients. At each client, the smaller model is initialized using the weights sent from the server and the entire process repeats.

Assume a central server which stores M pre-trained foundation models, each of which are parameterized as θ^{FM}^{₁}, θ^{FM}^{₂}, . . . , θ^{FM}^{_{M}}. The choice of foundation models can cover a broad spectrum of variations including but not limited to variations in architecture, loss function, pre-training dataset, etc. In addition to the foundation models, the server contains a smaller student model (θ^{DS}), which matches the backbone of the client's model and is used as the primary synchronization point for the clients. Overall, the server acts as an orchestrator for federated training, to send and receive information from the clients.

The federated learning system consists of N clients. Typically, the clients are restricted to use the least amount of hardware resources available. Thus, consider defaulting to using a common small model across all clients to mimic this behavior.

In general, the existence of a common public dataset (D^{p}, y^{p}) that is accessible to both the server and all clients. For each client-i, its locally stored data and model are denoted by (Dⁱ, yⁱ) and θⁱ respectively. In addition, within the context of federated training there are some key parameters like, number of epochs a client is trained in between each communication (to server) round, batch size, learning rate, optimizer type, and so on.

### Input

Central server (orchestrator) stores M number of pre-trained foundation models (deep neural networks) and a smaller student model θ_{DS} that mirrors the clients' model.

N clients in the federated learning system, where each client i has locally stored data (Dⁱ, yⁱ) and local model with initialized parameters θⁱ.

Public data (D^{p}, y^{p}) that is accessible to both server and clients.

### Steps

1. At the beginning of every round (r) of federated training, the server receives model parameters θⁱ from each client in [N]. The model parameters are aggregated and used to initialize θᵣ^{DS} in the following manner,

$${θ}_{r}^{DS} = {\sum }_{k = 1}^{N} \frac{\vert {D}_{k} \vert}{{\sum }_{i = 1}^{N} \vert {D}_{i} \vert} {θ}_{r}^{k} \qquad ( 10 )$$

Here, we reweigh the importance of each client model to match the amount of local data within each client, relative to the total amount data in the system.
2. After model aggregation is complete, the public dataset is used to distill knowledge from the pre-trained foundation models into the student model with aggregated parameters θᵣ^{DS}. The loss used for distillation is given by,

$$\frac{1}{\vert M \vert} {\sum }_{m = 1}^{M} {\sum }_{i = 1}^{C} {q}_{i}^{{FM}_{m}} log ( \frac{{q}_{i}^{{FM}_{m}}}{{q}_{i}^{DS}} ) , \qquad ( 11 )$$

termed the KL-Divergence loss [5] where

$${q}^{i} = \frac{exp ( {z}_{i} / T )}{{\sum }_{j = 1}^{C} exp ( {z}_{j} / T )} , {z}_{i}$$

denotes the logits of the i^{th} class and T denotes the distillation temperature.
3. When distillation is complete, the student model is broadcast to each client where the local model weights (θᵣ¹, θᵣ², . . . , θᵣ^{N}) are re-initialized to the student model broadcasted from the server (θᵣ^{DS}). Then the clients begin to train on their local data, (Dⁱ, yⁱ), using the loss dictated by

$${min}_{{θ}_{r}^{i}} \frac{1}{\vert {D}^{i} \vert} {\sum }_{d ∈ {D}^{i}} l ( {q}^{i} , {y}^{i} ) ,$$

where l( ) is the loss function.

Steps 1-3 are then repeated until the stop criterion is achieved (e.g., total number of rounds, loss/performance tolerance, etc.).

The machine-learning models described herein can be used in many different applications. As described above, the raw source data that is locally-stored may be image data, sound data, or the like, and thus various applications in which this data is retrieved or used are shown in FIGS. 6-11 as an example. Structure used for training and using the machine-learning models for these applications (and other applications) are exemplified in FIG. 5. FIG. 5 depicts a schematic diagram of an interaction between a computer-controlled machine 500 and a control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, microphone, ultrasonic and motion sensors. In one embodiment, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes a classifier 514. Classifier 514 may be configured to classify input signals x into one or more labels using a machine-learning algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., machine-learning algorithms, such as those described above) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may be any of the processors or processor subsystems described above with reference to FIGS. 1-2. and may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, tensor processing unit, graphics processing unit, ASIC or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more machine-learning algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the machine-learning algorithms and/or methodologies as disclosed herein. Non-volatile storage 516 may also include machine-learning data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIGS. 6-11 illustrate embodiments of environments in which the federated learning systems described herein can be implemented. Each of these embodiments show an embodiment of a client device. Data originating from the sensor 506 in these embodiments may be the raw source data that is used to train a machine learning model onboard the device (client), but not transferred to the server for protection of the data. FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, microphone, radar sensors, ultrasonic sensors, LiDAR sensors, and/or position sensors (e.g. GPS). One or more of the one or more specific sensors may be integrated into vehicle 600. Sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects. The raw source data for the federated learning may include the raw images of the vehicle surroundings, however the vehicle's processing of the objects in the surrounding environment might alter weights in the machine learning model used onboard the vehicle; these adjusted weights can then be sent back to the server's models for updating.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In another embodiment, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

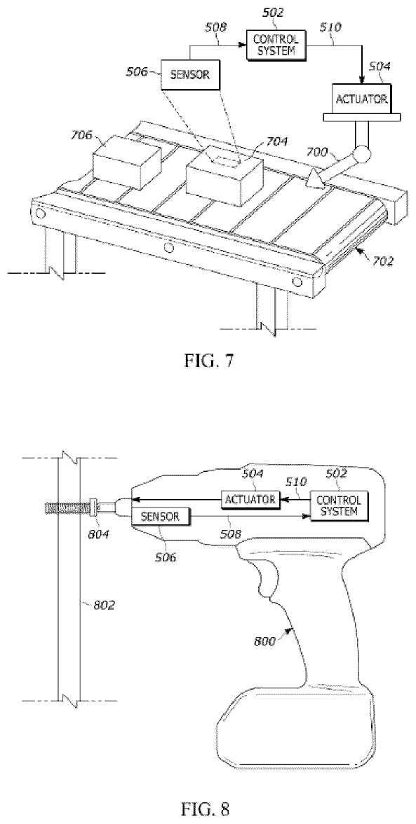

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 706 of system 700 (e.g., manufacturing machine) depending on the determined state of manufactured product 704.

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

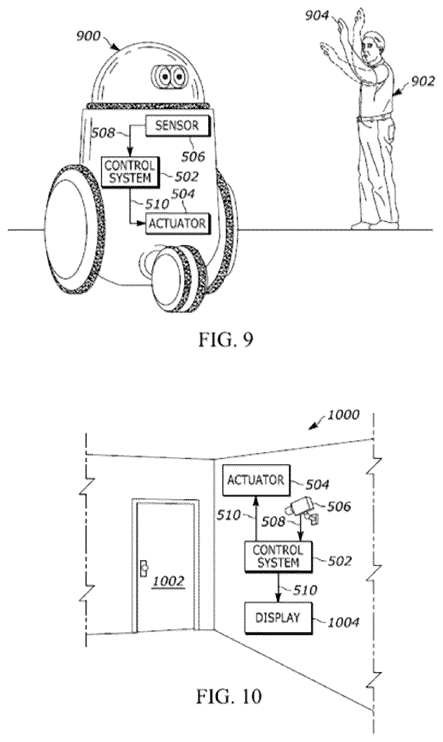

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In other embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

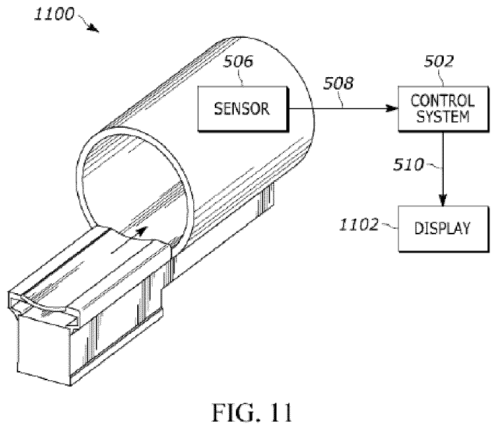

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region. The sensed image may be used internal in the hospital environment for training machine learning systems within the hospital (client), however this data is not sent to the server for training of the server's models. Instead, the hospital's adjusted weights that are adjusted based on the sensed images may be sent to the server for adjustment of the weights on the server side.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of training neural networks with federated learning, the method comprising:
sending at least a portion of a server-maintained machine learning model from a server to a plurality of clients, yielding a plurality of local machine learning models;
at each of the plurality of clients, training the plurality of local machine learning models with locally-stored data that is stored locally at that respective client, wherein training at each client includes determining a respective cross entropy loss for each of the plurality of local machine learning models;
updating respective weights for each of the plurality of local machine learning models;
transferring the respective updated weights from each client to the server without transferring the locally-stored data of the clients;
aggregating, at the server, respective weights from each of the plurality of local machine learning models to obtain an aggregated server-maintained machine learning model;
generating, at the server, a distillation loss based on a foundation model on the server;
updating, at the server, the aggregated server-maintained machine learning model to obtain updated aggregated respective weights;
transferring the updated aggregated respective weights to each of the plurality of clients; and
updating each of the plurality of local machine learning models with the updated aggregated respective weights.

2. The method of claim 1, wherein the aggregation is according to
$${θ}_{S}^{r} = {\sum }_{k = 1}^{N} \frac{1}{\vert {D}^{k} \vert} {θ}_{DS}^{k} .$$

3. A system of training neural networks with federated learning, the system comprising:
memory storing instructions; and
a plurality of processors that, when executing the instructions stored in the memory, collectively perform:
sending at least a portion of a server-maintained machine learning model from a server to a plurality of clients, yielding a plurality of local machine learning models;
at each of the plurality of clients, training the plurality of local machine learning models with locally-stored data that is stored locally at that respective client, wherein training at each client includes determining a respective cross entropy loss for each of the plurality of local machine learning models;
updating respective weights for each of the plurality of local machine learning models;
transferring the respective updated weights from each client to the server without transferring the locally-stored data of the clients;
aggregating, at the server, respective weights from each of the plurality of local machine learning models to obtain an aggregated server-maintained machine learning model;
generating, at the server, a distillation loss based on a foundation model on the server;
updating, at the server, the aggregated server-maintained machine learning model to obtain updated aggregated respective weights;
transferring the updated aggregated respective weights to each of the plurality of clients; and
updating each of the plurality of local machine learning models with the updated aggregated respective weights.

4. The method of claim 3, wherein the aggregation is according to
$${θ}_{S}^{r} = {\sum }_{k = 1}^{N} \frac{1}{\vert {D}^{k} \vert} {θ}_{DS}^{k} .$$

5. A robotic system operated by a neural network comprising:
memory storing instructions; and
at least one processor that, when executing the instructions stored in the memory, collectively train the neural networks with federated learning by:
sending at least a portion of a server-maintained machine learning model from a server to a plurality of clients, yielding a plurality of local machine learning models;
at each of the plurality of clients, training the plurality of local machine learning models with locally-stored data that is stored locally at that respective client, wherein training at each client includes determining a respective cross entropy loss for each of the plurality of local machine learning models;
updating respective weights for each of the plurality of local machine learning models;
transferring the respective updated weights from each client to the server without transferring the locally-stored data of the clients;
aggregating, at the server, respective weights from each of the plurality of local machine learning models to obtain an aggregated server-maintained machine learning model;
generating, at the server, a distillation loss based on a foundation model on the server;
updating, at the server, the aggregated server-maintained machine learning model to obtain updated aggregated respective weights;
transferring the updated aggregated respective weights to each of the plurality of clients; and
updating each of the plurality of local machine learning models with the updated aggregated respective weights.

6. The method of claim 5, wherein the aggregation is according to
$${θ}_{S}^{r} = {\sum }_{k = 1}^{N} \frac{1}{\vert {D}^{k} \vert} {θ}_{DS}^{k} .$$

7. The robotic system of claim 5, wherein the robotic system is an autonomous driving vehicle.

8. The robotic system of claim 5, wherein the robotic system is a medical system.
